(19) United States
(12) Patent Application Publication
(10) Pub. No.: US 2025/0345973 A1
(43) Pub. Date: Nov. 13, 2025

(54) TRANSMISSION DEVICE AND FORMING TOOL

(71) Applicant: Wolfgang Fassnacht, Bobingen (DE)

(72) Inventor: Wolfgang Fassnacht, Bobingen (DE)

(21) Appl. No.: 19/200,537

(22) Filed: May 6, 2025

(30) Foreign Application Priority Data
May 8, 2024 (EP) 24174706.2

(51) Int. Cl. B29C 45/16; B29C 45/26

(52) U.S. Cl. CPC B29C 45/162; B29C 45/2606

(57) ABSTRACT

A transmission device configured to transpose a drive movement of a drive into a linear and rotating movement of a first tool part of a forming tool of a forming device, the transmission device including a shaft, including a shaft axis; a first interface; a second interface, wherein the first interface is configured to connect the shaft with the first tool part at least torque proof, and the second interface is configured to connect the shaft with the drive at least by axial fixing; and a housing supporting the shaft is rotatable about the shaft axis and displaceable on a linear path parallel to the shaft axis, wherein at least one radial recess is arranged at an outer radial circumferential surface of the shaft, and at least one radial protrusion cooperating with the at least one radial recess is arranged at least at one guide element of the housing.

### RELATED APPLICATIONS

This application claims priority from and incorporates by reference European patent application 24 17 47 06.2, filed on May 8, 2024.

### FIELD OF THE INVENTION

The invention relates to a transmission configured to transpose a drive movement of at least one drive into a linear and rotating movement of a first tool part of a forming tool of a forming device, in particular of a plastic injection molding device, a forming tool of a forming device, in particular of an injection molding tool of a plastic injection molding device according to the preamble of claim 10 and a forming device, in particular a plastic injection molding device configured for injection molding of plastic injection molded parts, in particular for multi-component injection molding of multi-component injection molded parts according to the preamble of claim 15.

### BACKGROUND OF THE INVENTION

Several methods are known for injection molding multi-component or multi-color injection molded parts. When using the index plate method, the injection molding tool is configured so that an index plate is rotatable about a center axis and axially displaceable along the center axis. Thus, the index plate includes at least a portion of a first cavity in which a molded blank is created that can remain unchanged. After lifting the index plate from a stationary tool part, the index plate rotates about a predetermined angle and the molded blank is transported into a second cavity where a second component is molded onto the molded blank. Therefore, the index plate has to be moved by linear displacement and by rotation relative to the stationary tool part which is performed by two different drives in the prior art, namely, by a linear drive which moves an index shaft connected with the index plate by linear displacement and by an additional rotation drive which drives the index shaft to rotate.

The prior art for example, AT 505692B1 discloses a transmission device, a generic forming tool, and a generic forming device. Thus, the linear movement of index shaft and index plate is caused by hydraulic cylinders and the rotation of the index shaft and index plate is caused by an electric motor, wherein the rotation is transferred from the rotor through a transmission device onto the index shaft. Thus, two different drives are provided to implement a linear movement and a rotating movement of index shaft and index plate.

Thus, it is an object of the invention to provide a transmission device for a forming tool which facilitates a linear movement and a rotating movement of a tool part of the forming tool by simple means. Additionally, a forming tool with the transmission device shall be provided and a forming device with the forming tool.

### BRIEF SUMMARY OF THE INVENTION

The object is achieved by the features of the independent claims.

A first embodiment of the invention relates to a transmission device configured to transpose a drive movement of a drive into a linear and rotating movement of a first tool part of a forming tool of a forming device, in particular, of a plastic injection molding device, the transmission device comprising:
a) a shaft, including a shaft axis, a first interface, and a second interface, wherein the first interface is configured to connect the shaft with the first tool part at least torque proof, and the second interface is configured to connect the shaft with the drive at least by axial fixing,
b) a housing, in which the shaft is supported rotatable about the shaft axis and displaceable on a linear path parallel to the shaft axis, wherein
c) at least one radial recess is arranged at an outer radial circumferential surface of the shaft and at least one radial protrusion cooperating with the recess is arranged at least at one guide element of the housing, or
d) a radial protrusion is arranged at a radially outer circumferential surface of the shaft and at least one radial recess that cooperates with the radial protrusion is arranged at a radially inner circumferential surface of a guide element of the housing, and
e) wherein the at least one radial recess includes at least one linear recess section oriented parallel to the shaft axis and at least one helix-shaped recess section extending coaxial with the shaft axis and wherein the at least one radial protrusion radially protrudes into the at least one radial recess so that the at least one radial protrusion is configured to slide along or in the at least one radial recess, and
f) wherein the at least one linear recess section and the at least one helix-shaped recess section are connected so that the at least one radial protrusion is able to slide from the at least one linear recess section into the at least one helix-shaped recess section and/or from the at least one helix-shaped recess section into the at least one linear recess section when the shaft is actuated by the drive to move on an exclusively linear path parallel to the shaft axis.

Through the exclusively linear actuation of the shaft parallel to the shaft axis, the at least one radial protrusion can cooperate serially with a linear recess section and with a helix-shaped recess section which causes a kinematic connection that causes a combined linear and rotating movement of the shaft. Then only a single drive is required that is configured to actuate the shaft on a linear path parallel to the shaft axis, wherein the drive is configured to actuate the shaft in a linear direction parallel to the shaft axis, namely in particular a linear drive. The additional rotation drive required in the prior art can then be omitted.

A desired combination of linear and rotating movement of the shaft can then be implemented by a corresponding serial arrangement of linear and helix-shaped recess sections at the shaft or at the guide element.

The transmission device therefore includes two basic embodiments, namely a first embodiment where the radial recess is configured at the shaft and the radial protrusion is configured at the guide element and a kinematically reversed second embodiment where the radial recess is arranged at the guide element and the radial protrusion is arranged at the shaft.

The guide element can include in particular at least one bushing or a bushing-shaped body that is connected with the housing. In this case, either the at least one radial protrusion or the at least one radial recess can be configured at a radially inner circumferential surface of the bushing depending on the embodiment.

The transmission device according to the invention essentially implements a linear and rotary forced coupling between the shaft and the guide element. As an additional advantage, modified kinematics with respect to the linear and rotating movement pattern of the shaft can be implemented by simply replacing the shaft and/or the guide element depending on where the at least one radial recess is arranged.

The dependent claims specify advantageous improvements of the transmission device according to the independent claims.

Particularly advantageously the at least one radial protrusion cooperates with the at least one radial recess so that an exclusively linear actuation of the shaft parallel to the shaft axis caused by the drive
a.) displaces the shaft on a linear path parallel to the shaft axis when the radial protrusion comes into engagement with the at least one linear recess section during the linear actuation of the shaft, and
b.) the shaft is displaced parallel to the shaft axis on a linear path and additionally rotates about the shaft axis when the protrusion engages or comes into engagement with the at least one helix-shaped recess section during the linear actuation of the shaft.

In order to provide an arrangement that is simple to manufacture, the at least one radial recess is configured as a groove and the at least one radial protrusion is configured as a sliding block that radially protrudes into the groove.

The shaft and/or the guide element can be produced as injection-molded parts or by chipping fabrication or by additive fabrication.

An embodiment that provides particularly stable support can be implemented in that the transmission device includes plural radial protrusions that are arranged diametrically opposed with respect to the shaft axis and which simultaneously
a.) cooperate with plural linear recesses, and/or
b.) with plural helix-shaped recesses.

The at least one helix-shaped recess section can be configured so that the shaft rotates by a predetermined angle, in particular by 90 degrees, when the at least one radial protrusion slides between two ends of the at least one helix-shaped recess section.

In an advantageous embodiment of the transmission device, at least one branching or joining location of the radial recess
a.) includes at least one helix-shaped recess section adjoining at least one linear recess section, and/or
b.) at least one linear recess section adjoining at least one helix-shaped recess section.

Advantageously, the transmission device includes at least one linear recess section and at least one helix-shaped recess section, configured and arranged so that the shaft is caused by the first linear actuation in a first linear actuation direction from a linear starting position into a linear reversal position and by a subsequent second actuation that is opposite to the first linear actuation of the shaft in a second linear actuation direction from the linear reversal position back into the linear starting position, to perform a rotation about a predetermined angle, in particular, by 180 degrees.

When two helix-shaped recess sections adjoin a linear recess section, the two helix-shaped recess sections can diverge starting from the branch-off or joining location in particular at an acute angle. Vice versa, when a linear recess section adjoins two helix-shaped recess sections, the two helix-shaped recess sections can converge at the branch-off or joining location, in particular at an acute angle.

In order to assure a safe engagement or penetration of the radial protrusion into one of the two helix-shaped recess sections at the branch-off or joining location, it can be provided that one helix-shaped recess section of the two helix-shaped recess sections is displaced on a linear path with respect to the other of the two helix-shaped recess sections relative to the shaft axis.

Two opposite linear actuations of the shaft, namely, a first actuation of the shaft in a first actuation direction, and a second actuation of the shaft in a second actuation direction can implement a rotation of the shaft by e.g. 180 degrees in combination with a reversing linear movement of the shaft and thus of the first tool part between a linear starting position and a linear reversal position.

In an advantageously embodiment, the transmission device includes
a) two linear first recess sections and two linear second recess sections respectively arranged diametrically opposed with respect to the shaft axis, and
b) two helix-shaped first recess sections and two helix-shaped second recess sections, wherein the helix-shaped first and second recess sections are coaxial with reference to the shaft axis; and
c) two first branch-off and joining locations between the linear first recess sections and the helix-shaped first and second recess sections and two second branch-off and joining locations between the helix-shaped first and second recess sections and the linear second recess sections, wherein the first and second branch-off and joining locations are respectively arranged diametrically opposed with respect to the shaft axis, and
d) two radial protrusions, a first radial protrusion and a second radial protrusion arranged diametrically opposed with respect to the shaft axis.

The transmission device can be advantageously configured so that
a) the radial protrusions slide along the first linear recess sections, which causes a linear movement of the shaft in the first linear actuation direction when the shaft is actuated during the first linear movement in the first linear actuation direction from the linear starting position, and thereafter
b) the radial protrusions slide during the continued first linear actuation at the first branch-off and joining locations from the linear first recess sections into the helix-shaped first and second recess sections, and thereafter
c) the radial protrusions slide along the helix-shaped first and second recess sections during a continued first linear actuation which causes a rotation of the shaft in a rotation direction and a linear movement of the shaft in the first linear actuation direction, and thereafter
d) the radial protrusions slide at the second branch-off and joining locations from the helix-shaped first and second actuation sections into the linear second recess sections, and thereafter
e) the radial protrusions slide in the second linear recess sections during the continued first linear actuation, until the linear reversal position of the shaft is reached, and
f) the radial protrusions slide along the linear second recess sections in the second linear actuation direction when the shaft is actuated in a second linear actuation direction that is arranged opposite to the first linear actuation direction when the reversal position is reached, and thereafter
g) the radial protrusions slide at the second branch-off and joining locations out of the linear second recess sections and into the helix-shaped first and second recess sections during the continued second linear actuation of the shaft, and thereafter
h) the radial protrusions slide along the helix-shaped first and second helix-shaped recess sections during a continued second linear actuation which causes in particular a linear movement of the shaft in the second linear actuation direction and an additional rotation of the shaft in the same rotation direction, and thereafter
i) the radial protrusions slide at the first branch-off and joining locations from the helix-shaped first and second recess sections into the linear first recess sections during the continued second linear actuation, and thereafter
j) the radial protrusions slide in the linear first recess sections during a continued second linear actuation until the shaft has reached the linear starting position again.

According to an advantageous embodiment, the helix shaped first recess sections and the helix shaped second recess sections are advantageously configured so that the shaft respectively rotates by 90 degrees when the radial protrusions slide between two end positions of the helix-shaped first and second recess sections. The end positions are respectively arranged at the first and second branch-off and joining positions recited supra. As stated supra, the shaft and thus the first tool part have performed a rotation of 180 degrees and a linear and reversing stroke movement between the first linear starting position and the linear reversal position.

It is self evident that the embodiments recited supra are exemplary only and an infinite number of rotating and linear actuation patterns of the shaft and thus of the first tool part can be implemented as a function of the arrangement, embodiment and number of linear and helix-shaped recess sections.

According to another embodiment of the invention a forming tool of a forming arrangement is provided, in particular, an injection molding tool of a plastic injection molding device, the forming tool comprising:
a) the transmission device described supra;
b) the first tool part of the forming tool,
c) a second tool part of the forming tool cooperating with the first tool part, wherein
d) the first tool part is moved relative to the second tool part on a linear path and/or rotated due to the linear actuation of the shaft of the transmission device parallel to the shaft axis.

Depending on the embodiment of the transmission device according to the invention, a plethora of kinematic embodiments of a forming tool can be provided with respect to the linear and/or rotating movement abilities of the first tool part.

In an advantageous embodiment of the forming tool, the first tool part and the second tool part are moveable due to the linear actuation of the shaft of the transmission device, thus moveable between a contact position in which the first tool part and the second tool part contact along a separation plane and a lifted-off position in which the first tool part is lifted off from the second tool part and/or rotated, in particular rotated relative to one another with respect to the shaft axis linear and/or by rotation, when the rotation advantageously covers 180 degrees.

Advantageously, the forming tool can include an index plate tool, and the shaft includes an index shaft, the first tool part includes an index plate connected by the shaft through the first interface torque-proof and axially fixed and the second tool part includes a form plate that is stationary in particular.

In an advantageous embodiment of the forming tool, the index plate can be configured to move at least one plastic injection-molded part, in particular, during a multi-component injection molding method to different injection molding stations of the forming device.

The forming plate of the forming tool and/or the index plate can include form cavities which are associated with different injection molding stations of the forming device.

In another advantageous embodiment, the invention includes a forming device in particular, a plastic injection molding device configured to mold plastic injection molded parts, in particular configured to mold multi-component plastic injection molded parts by multi-component injection molding, the forming device comprising:
a.) at least one forming tool described supra;
b.) a reversable linear drive that is connected with the second interface of the shaft in order to drive the shaft on a linear path and reversibly parallel to the shaft axis, in particular between the linear starting position recited supra and the linear reversal position; and
c.) at least one plasticizer configured to melt and homogenize at least one synthetic material.

Multi-component injection molding shall also include a layered fabrication of an injection-molded component from an identical synthetic material in addition to multi-component injection molding from plural plastic materials.

A particular advantageous embodiment of the invention relates to a transmission device configured to transpose a drive movement of a drive into a linear and rotating movement of a first tool part of a forming tool of a forming device, the transmission device including
a) a shaft, including a shaft axis, a first interface, and a second interface, wherein the first interface is configured to connect the shaft with the first tool part;
b) a housing, in which the shaft is supported rotatable about the shaft axis and displaceable on a linear path parallel to the shaft axis, wherein
c) at least one radial recess is arranged at an outer radial circumferential surface of the shaft and at least one radial protrusion cooperating with the recess is arranged at least at one guide element of the housing, or
d) at least one radial protrusion is arranged at a radially outer circumferential surface of the shaft and at least one radial recess that cooperates with the radial protrusion is arranged at a radially inner circumferential surface of a guide element of the housing, and
e) wherein the at least one radial recess includes at least one linear recess section oriented parallel to the shaft axis and at least one helix-shaped recess section extending coaxial with the shaft axis and wherein the at least one radial protrusion radially protrudes into the at least one radial recess so that the at least one radial protrusion is configured to slide along or in the at least one radial recess, and
f) wherein the at least one linear recess section and the at least one helix-shaped recess section are connected so that the at least one radial protrusion is able to slide from the at least one linear recess section into the at least one helix-shaped recess section and/or from the at least one helix-shaped recess section into the at least one linear recess section when the shaft is actuated by the drive to move on an exclusively linear path parallel to the shaft axis,
g) wherein at least one branch off or joining location of the at least one radial recess includes
g1) two helix shaped recess sections adjoining a linear recess section, wherein the two helix shaped recess sections branch off from the branch off and joining location, or
g2) a linear recess section adjoins two helix shaped recess sections, wherein the helix shaped recess sections converge from the branch-off and joining location.

The helix shaped recess sections diverging or converging at the at least one branch-off or joining location facilitate a large number of rotation positions of the shaft and thus several injection molding stations along the forward and return stroke of the shaft.

The linear drive can also be configured as a piston-cylinder drive.

### BRIEF DESCRIPTION OF THE DRAWINGS

Other measures improving the invention are subsequently described based on an embodiment of the invention with reference to drawing figures, wherein

FIG. 1 illustrates a cross-sectional view of an advantageous embodiment of the transmission device according to the invention including an index plate attached thereon;

FIG. 2A illustrates a schematic and perspective view of the transmission device of FIG. 1;

FIG. 2B illustrates a schematic top view of the transmission device of FIG. 1;

FIG. 2C illustrates a schematic front view of the transmission device of FIG. 1;

FIG. 3A illustrates a schematic and perspective side view of the transmission device of FIG. 1;

FIG. 3B illustrates a schematic and perspective bottom view of the transmission device of FIG. 1;

FIG. 4 illustrates schematic and perspective side views of the transmission device of FIG. 1 in different linear and rotated positions;

FIG. 5 illustrates a cross-section view of an advantageous embodiment of a forming tool including the transmission device of FIG. 1.

### DETAILED DESCRIPTION OF THE INVENTION

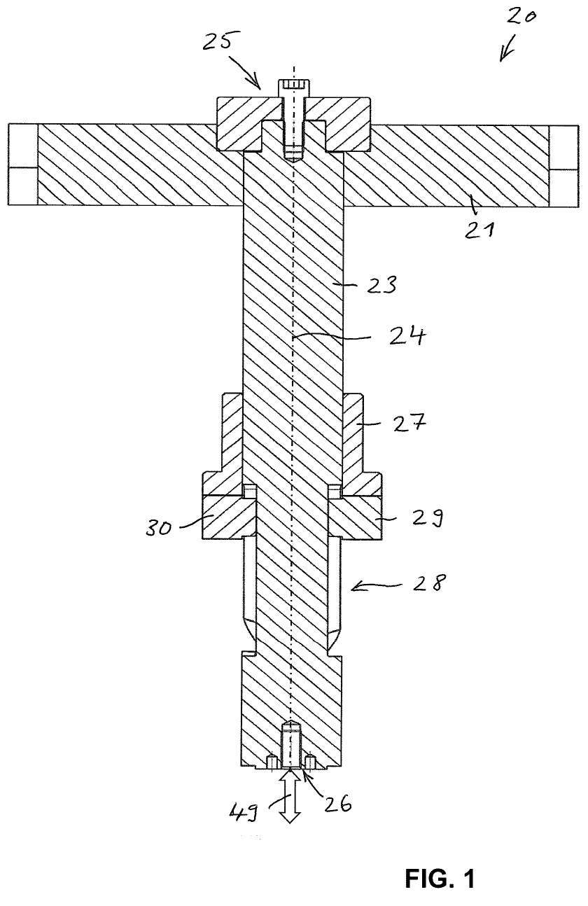

FIG. 1 shows a cross-section view of an advantageous embodiment of a transmission device 20 overall designated with reference numeral 1.

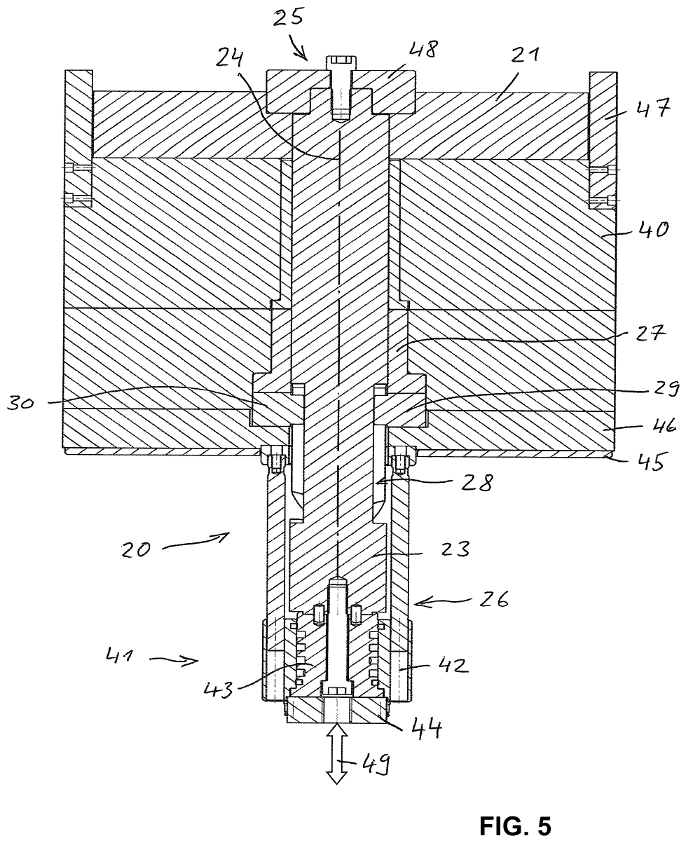

The transmission device 1 is configured to transpose or convert a drive movement of a linear drive into a combined linear and rotating movement of e.g. an index plate 21 shown in FIG. 5 of a plastic injection molding tool 22 of a plastic injection-molding device. The linear drive forms part of the plastic injection-molding device.

The transmission device 20 includes a shaft 23 with a shaft axis 24, a first interface 25 and a second interface 26, wherein the first interface 25 is configured to connect the shaft 23 with the index plate 21, e.g., torque-proof and axially fixed and the second interface is configured to connect the shaft 23 with the linear drive, e.g., torque-proof and axially fixed.

The transmission device 20 additionally includes a housing in which the shaft 23 is rotatably supported about the shaft axis 24 and supported moveable on a linear path parallel to the shaft axis 24. For the purposes of clarity, FIG. 1 only shows a support element 27 for the shaft 23 instead of showing the entire housing, thus a bushing with a central pass-through opening wherein the shaft 23 extends through the bushing. Thus, the shaft 23 is supported rotatable and moveable on a linear path at the support element 27 or by the support element 27 in the housing and is thus only driven on a linear path by the linear drive engaging the second interface directly or indirectly.

Radial recesses 28 are configured at a radially outer circumferential surface of the shaft 23 in the illustrated advantageous embodiment of the transmission device 20, wherein the radial recesses 28 are configured e.g., as grooves, so that two sliding blocks 29, 30 diametrically opposed with respect to the shaft axis protrude into the radial recesses 28 so that the sliding blocks 29, 30 can slide in the radial recesses 28 or along the radial recesses 28 like in a slotted link transmission. The two sliding blocks 29, 30 are axially fixed at the support element or the bushing 27, whereas the support element or the bushing 27 is connected with the housing and therefore stationary.

This principle can be reversed so that radial protrusions are arranged at a radially outer circumferential surface of the shaft 23 and cooperate with complimentary recesses of the support element 27, thus e.g. the bushing forming a slotted link transmission.

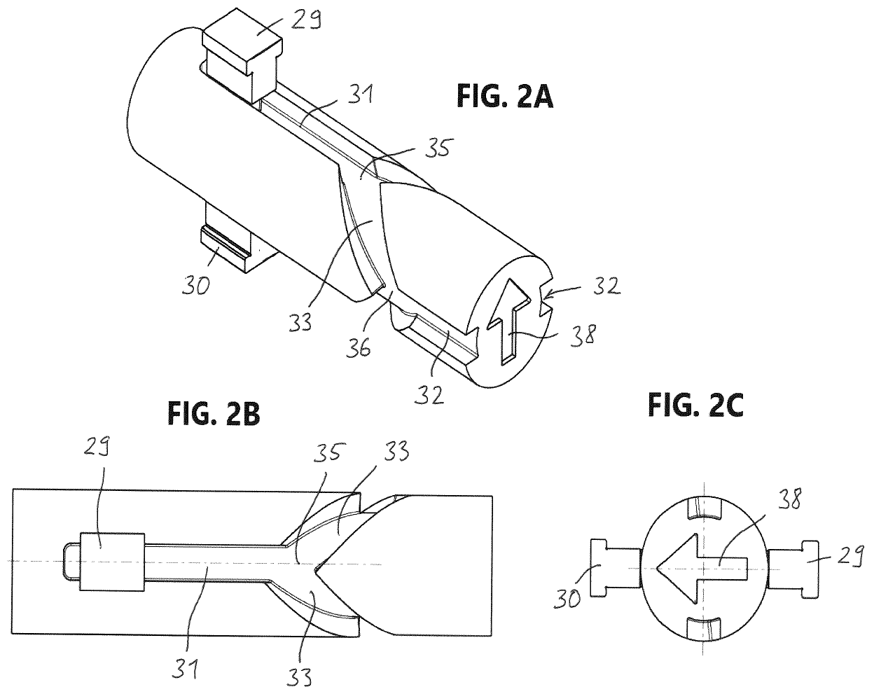

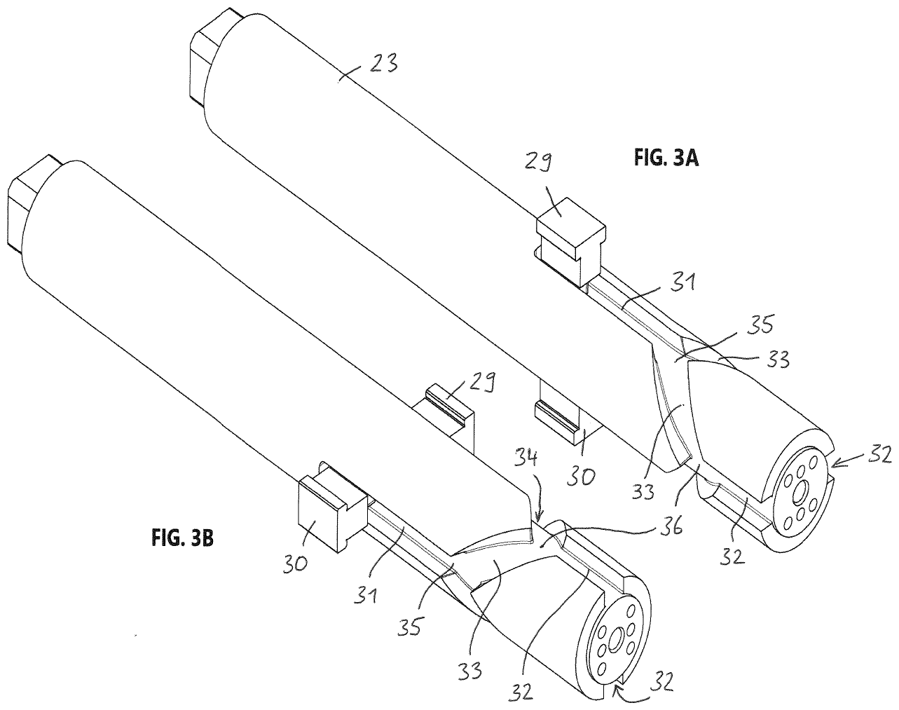

As evident from FIG. 2A through FIGS. 2C, 3A, and 3B, and 4, the radial recesses 28 include linear first recess sections 31 and linear second recess sections 32 parallel to the shaft axis 24 that are arranged diametrically opposed relative to the shaft axis 24. Additionally, the radial recesses 28 include two helix-shaped first recess sections 33 coaxial to the shaft axis 24 and two helix-shaped second recess sections 34 coaxial to the shaft axis 24, wherein the helix-shaped first and second recess sections 33, 34 are arranged in particular diametrically opposed with respect to the shaft axis 24 and in particular mirror symmetrical to a plane including the shaft axis 24.

The radial recesses 28 also include two first branch-off and joining locations 35 between the linear first recess section 32 and the helix-shaped first and second recess sections 33, 34 and two second branch-off and joining locations 36 between the helix shaped first and second recess sections 33, 34 and the linear second recess section 32, wherein the first and second branch-off and joining locations 35, 36 are respectively arranged diametrically and axially offset relative to the shaft axis 24. The helix-shaped first and second recess sections 33, 34 diverge or converge at the first and second branch-off and joining locations 35, 36, in particular, at an acute angle.

Last, not least, the first radial sliding block 29 and the second radial sliding block 30 are arranged diametrically opposed with respect to the shaft axis 24 at the support element 27.

The radial recess sections 28 are configured so that the two sliding blocks 29, 30 can slide from the linear recess sections 31, 32 into the helix-shaped recess sections 33, 34 and vice versa, through the accordingly configured first and second branch-off and joining locations 35, 36 between the linear and helix-shaped recess sections 31, 32 or 33, 34.

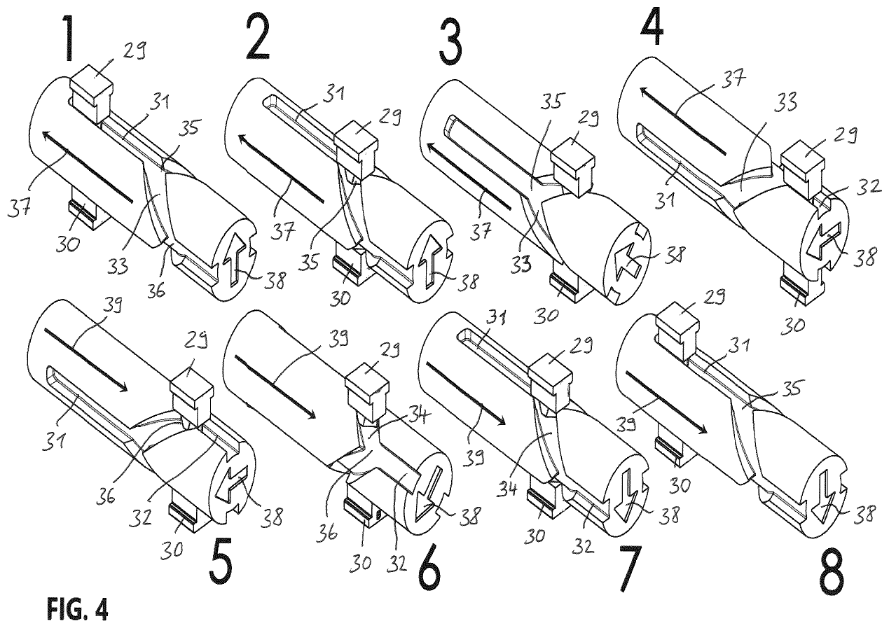

The function of the transmission device 20 is now described with reference to FIG. 4.

The linear drive actuates the shaft 23 arranged in a linear starting position (e.g. zero) in the condition “1” of FIG. 4 in a first linear actuation direction which is indicated in FIG. 4 by the first arrow 37. Thereafter, the two sliding blocks 29, 30 slide from the linear starting position of the shaft 23 along the linear first recess sections 31, 32. The angular position of the shaft 23 is indicated in FIG. 4 by the second arrow 38 and is zero degrees in the linear starting position of the shaft in the condition of “1” and along the linear first recess sections 31, 32 as indicated by the second arrow 38 in FIG. 4.

The linear starting position of the shaft 23 can be stored e.g. in a control of the linear drive and/or detected by an end position switch that cooperates with the control.

The two sliding blocks 29, 30 slide along the two linear first recess sections 31, 32 to the two first branch-off and joining locations 35 during the first linear actuation in the first linear actuation direction 37 continued by the linear drive, so that the shaft 23 has arrived in the condition “2” of FIG. 4 in which it has travelled a path corresponding to the length of the first linear recess sections 31, 32 parallel to the shaft axis 24, but has not performed a rotation yet so that the angular starting position, e.g. zero degrees, is still provided.

The two sliding blocks 29, 30 then slide during the continued first linear actuation of the shaft 23 by the linear drive in the first linear actuation direction 37 at the first branch-off and joining location 35 from the two linear first recess sections 31, 32 into the helix-shaped first and second recess sections 33, 34 and along the first and second recess sections 33, 34 so that the shaft 23 can assume the condition designated as “3” in FIG. 4, where it is moved by an additional distance in the first actuation direction 37 from the linear starting position and rotated by a predetermined angle relative to the angular starting position as illustrated by the second arrow 38.

The two sliding blocks 29, 30 arrive at the second branch-off and joining positions 36 during the continued first linear movement of the shaft 23 in the first linear actuation direction 37 where the two sliding blocks slide out of the helix-shaped first and second recess sections 34 and into the linear second recess sections 32. This condition is designated as “4” in FIG. 4. Compared to the condition “3”, the shaft 23 is moved by and additional distance in the first actuation direction 37 from the linear starting position and rotated by an additional angle relative to the angular starting position as indicated by the arrow 38.

The two sliding blocks 29, 30 slide in the linear second recess sections 32 during the continued first linear actuation in the first actuation direction 37 until a linear reversal position of the shaft 23 is reached which is arranged e.g., at an end of the linear second recess sections 32. In the reversal position, the shaft 23 is at an angular position of 90 degrees relative to the angular starting position.

The linear reversal position of the shaft 23 is stored, e.g., in a memory of the control of the linear drive, so that the linear drive can be switched into a reversal operation when reaching the linear reversal position, wherein the linear drive can drive the shaft 23 on a linear path during a second actuation in a second actuation direction, indicated in FIG. 4 by a third arrow 39. Alternatively, or additionally, an additional end switch can be provided which detects the reversal position of the shaft 23 and reports the reversal position to the control of the linear drive.

When the shaft continues to be actuated by the linear drive in the second linear actuation direction 39 during the continued second linear actuation, the two sliding blocks 29, 30 slide along the linear second recess sections 32 until the second branch-off and joining locations 36 are reached. This condition is designated as “5” in FIG. 4. This does not change the angular position as illustrated by the second arrow 38, however, the linear position of the shaft 23 is then moved by an incremental distance from the reversal position in a direction back to the starting position.

When the second linear actuation of the shaft is continued in the second linear actuation direction 39, the two sliding blocks 29, 30 slide along the second branch-off and joining locations 36 out of the linear second recess sections 32 and back into the helix-shaped first and second recess sections 33, 34, so that the shaft 23 moves into the condition “6” in FIG. 4, where it is moved in a linear direction by an additional increment relative to the condition “5” from the linear reversal position and into and in a direction towards the linear starting position. Additionally, the angular position of the shaft 23 has changed as well, so that this position now differs from the angular starting position by more than 90 degrees.

When the second linear actuation continues in the second linear actuation direction 37, the two sliding blocks 29, 30 slide in the helix-shaped first and second recess sections 33, 34 until the first branch-off and joining locations 35 are reached again. This condition is designated as “7” in FIG. 4. Compared to the condition “6”, the shaft is moved by an additional increment from the linear reversal position back in a direction towards the linear starting position. Additionally, the angular position of the shaft 23 has changed as well, which is now 180 degrees relative to the angular starting position as indicated by the second arrow 38.

When the second linear actuation continues in the second linear actuation direction 39, the two sliding blocks 29, 30 slide at the first branch-off and joining location 35 from the helix-shaped first recess sections 33, 34 into the linear first recess sections 31 and slide in the first recess sections 31 until the shaft 23 has reached the linear starting position “1” again which it assumes also in the condition “8” where the two sliding blocks 29, 30 have advantageously reached the ends of the first linear recess sections again. Thus, the angular position of the shaft 23 remains unchanged.

The shaft 23 is driven exclusively linearly by the linear drive between the linear starting position and the reversal position and thus performs a rotation of e.g., 180 degrees during the cycle described supra and as illustrated by the change of the direction of the second arrow 38 in FIG. 4. Since the index plate 21 is connected at the first interface 25 with the shaft 23 at least torque-proof, the rotating and linear movements of the shaft 23 described supra then also apply to the index plate 21.

The transmission device 20 and the reversing linear drive of the shaft 23 causes the index plate 21 coupled with the shaft 23 in linear displacement and rotation to perform a lift-off movement from a second tool part of the plastic injection-molding tool 22 and a rotation of e.g. 180 degrees, so that blanks transported by the index plate 21 during multi-component injection molding can move into different injection-molding stations of the plastic injection-molding device in order to be provided with another layer of plastic material.

FIG. 5 shows another embodiment using the transmission device 20 recited supra in an advantageous embodiment of the plastic injection-molding tool 22. In addition to the transmission device 20 the plastic injection-molding tool 22 includes a cooling device 41 axially attached to the second interface 26, wherein the cooling device 41 includes a cooling bell 42 and a cooling insert 43, wherein the shaft 23 is actuated axially reversing by an actuation plate 44 connected with the cooling device 41 as indicated by the fourth arrow in FIG. 5. Thus, the cooling device 41 is connected with the second interface 26 of the shaft 23.

Additionally, the plastic injection-molding tool 22 includes a heat insulation plate 45, a clamping plate 46, and a mold plate configured as the second tool part 40. Additionally, a guide plate 47 is provided which supports the index plate 21 at the mold plate 40 axially, this means parallel to the shaft axis 24.

Due to the kinematics of the transmission device 20, the index plate 21 is reversibly axially moveable relative to the mold plate 40 in a direction of the shaft axis 24, this means in the first and second actuation directions 37, 39 described supra, and about the shaft axis 24, e.g. by 180 degrees. A drive dog attached at the first interface 25 of the shaft 23 provides an axially fixed and torque-proof connection of the index plate at the shaft 23.

It is evident from FIG. 5 that the index plate 21 can be axially lifted from the mold plate 40 and rotated relative to the mold plate 40 exclusively by a reversing linear actuation of the shaft 23, indicated by a fourth arrow 49 and caused by a linear drive connected with the actuation plate 44, e.g. a cylinder-piston drive 21.

As evident from FIG. 4, positions 1-8, the branch off or joining location 35, 36 of the at least one radial recess includes two helix shaped recess sections 33, 34 adjoining a linear recess section 31, 32, wherein the two helix shaped recess sections 33, 34 diverge from the branch off and joining location 35, 36, or a linear recess section 31, 32 adjoins two helix shaped recess sections 33, 34, wherein the helix shaped recess sections 33, 34 converge from the branch-off and joining location 35, 36.

The helix shaped recess sections 33, 34 diverging or converging at the at least one branch-off or joining location 35, 36 advantageously facilitate a large number of rotation positions of the shaft 23 and thus several injection molding stations along the forward and return stroke of the shaft 23.

### REFERENCE NUMERALS AND DESIGNATIONS

1-8 conditions of the shaft or the index plate
20 transmission device
21 index plate
22 plastic injection-molding tool
23 shaft
24 shaft axis
25 first interface
26 second interface
27 support element
28 radial recess
29 first sliding block
30 second sliding block
31 linear first recess section
32 linear second recess section
33 helix-shaped first recess section
34 helix-shaped second recess section
35 first branch-off and joining location
36 second branch-off and joining location
37 first arrow, first linear actuation direction
38 second arrow
39 third arrow, second linear actuation direction
40 second tool part, mold plate
41 cooling device
42 cooling bell
43 cooling insert
44 actuation plate
45 heat insulation plate
46 clamping plate
47 guide bar
48 drive dog
49 fourth arrow, reversing actuation.

What is claimed is:

1. A transmission device configured to transpose a drive movement of a drive into a linear and rotating movement of a first tool part of a forming tool of a forming device, the transmission device comprising:
a shaft, including a shaft axis;
a first interface;
a second interface,
wherein the first interface is configured to connect the shaft with the first tool part at least torque proof, and the second interface is configured to connect the shaft with the drive at least by axial fixing; and
a housing, in which the shaft is supported rotatable about the shaft axis and displaceable on a linear path parallel to the shaft axis,
wherein at least one radial recess is arranged at an outer radial circumferential surface of the shaft, and at least one radial protrusion cooperating with the at least one radial recess is arranged at least at one guide element of the housing, or
wherein the at least one radial protrusion is arranged at a radially outer circumferential surface of the shaft and the at least one radial recess that cooperates with the at least one radial protrusion is arranged at a radially inner circumferential surface of the at least one guide element of the housing, and
wherein the at least one radial recess includes at least one linear recess section oriented parallel to the shaft axis and at least one helix-shaped recess section extending coaxial with the shaft axis, and wherein the at least one radial protrusion radially protrudes into the at least one radial recess, so that the at least one radial protrusion is configured to slide along or in the at least one radial recess, and
wherein the at least one linear recess section and the at least one helix-shaped recess section are connected so that the at least one radial protrusion is able to slide from the at least one linear recess section into the at least one helix-shaped recess section and/or from the at least one helix-shaped recess section into the at least one linear recess section when the shaft is actuated by the drive to move on an exclusively linear path parallel to the shaft axis.

2. The transmission device according to claim 1,
wherein the at least one radial protrusion cooperates with the at least one radial recess, so that an exclusively linear actuation of the shaft parallel to the shaft axis caused by the drive
displaces the shaft on a linear path parallel to the shaft axis when the at least one radial protrusion engages the at least one linear recess section during the linear actuation of the shaft, and
the shaft is displaced parallel to the shaft axis on a linear path and additionally rotates about the shaft axis when the at least one radial protrusion engages or comes into engagement with the at least one helix-shaped recess section during the linear actuation of the shaft.

3. The transmission device according to claim 1, wherein the at least one radial recess is configured as a groove and the at least one radial protrusion is configured as a sliding block radially protruding into the groove.

4. The transmission device according to claim 1,
wherein the at least one radial protrusion includes plural radial protrusions arranged diametrically opposed relative to the shaft axis, which simultaneously
cooperate with the at least one linear recess section configured as plural linear recess sections, and/or
cooperate with the at least one helix shaped recess section configured as plural helix-shaped recess sections.

5. The transmission device according to claim 1, wherein the at least one helix-shaped recess section is configured so that the shaft is rotated by a predetermined angle, or by 90 degrees when the at least one radial protrusion slides between two ends of the at least one helix-shaped recess section.

6. The transmission device according to claim 1, wherein at least one branching or joining location of the at least one radial recess
includes the at least one helix-shaped recess section adjoining the at least one linear recess section, and/or
includes the at least one linear recess section adjoining the at least one helix-shaped recess section.

7. The transmission device according to claim 1,
wherein the at least one linear recess section includes the two linear first recess sections and two linear second recess sections respectively arranged diametrically opposed relative to the shaft axis,
wherein the at least one helix shaped recess section includes two helix-shaped first recess sections and two helix-shaped second recess sections, wherein the two helix-shaped first recess sections and the two helix-shaped second recess sections are coaxial relative to the shaft axis,
wherein four branch off and joining locations including two first branch-off and joining locations are arranged between the linear first recess sections (31) and the helix-shaped first recess sections and the second helix-shaped recess sections (34) and two second branch-off and joining locations are arranged between the helix-shaped first recess sections and the helix-shaped second recess sections and the linear second recess sections, wherein the first branch-off and joining locations and second branch-off and joining locations are respectively arranged diametrically opposed with respect to the shaft axis, and
wherein the at least one radial protrusion includes two radial protrusions including a first radial protrusion and a second radial protrusion arranged diametrically opposed with respect to the shaft axis.

8. The transmission device according to claim 7, wherein the at least one linear recess section, and/or the at least one helix-shaped recess section are configured and arranged so that the shaft performs a rotation about a predetermined angle, or about 180 degrees caused by a first linear actuation in a first linear actuation direction from a linear starting position to a linear reversal position and caused by a subsequent second linear actuation in a second linear actuation direction from the linear reversal position back into the linear starting position, wherein the second linear actuation is opposite to the first linear actuation.

9. The transmission device according to claim 8, configured so that
the radial protrusions slide along the first linear recess sections caused by the first linear actuation of the shaft in the first linear actuation direction from the linear starting position, and thereafter
the radial protrusions slide from the linear first recess sections at the first branch-off and joining locations into the helix-shaped first recess sections and the helix-shaped second recess sections during continued first linear actuation, and thereafter
the radial protrusions slide along the helix-shaped first recess sections and the helix-shaped second recess sections during continued first linear actuation, and thereafter
the radial protrusions slide at the second branch-off and joining locations from the helix-shaped first recess sections and the helix shaped second recess sections into the linear second recess sections, and thereafter
the radial protrusions slide in the second linear recess sections during continued first linear actuation, until a linear reversal position of the shaft is reached, and thereafter
the radial protrusions slide along the linear second recess sections in the second linear actuation direction when the shaft is actuated in a second linear actuation direction that is oriented opposite to the first linear actuation direction when the reversal position is reached, and thereafter
the radial protrusions slide at the second branch-off and joining locations out of the linear second recess sections and into the helix-shaped first recess sections and the helix-shaped second recess sections during continued second linear actuation of the shaft, and thereafter
the radial protrusions slide along the helix-shaped first recess sections and the helix-shaped second recess sections during the continued second linear actuation, and thereafter
the radial protrusions slide at the first branch-off and joining locations from the helix-shaped first recess sections and the helix shaped second recess sections into the linear first recess sections during the continued second linear actuation, and thereafter
the radial protrusions slide in the linear first recess sections during continued second linear actuation until the shaft has reached the linear starting position again.

10. A forming tool of a forming device, the forming tool comprising:
the transmission device according to claim 1;
the first tool part of the forming tool; and
a second tool part of the forming tool cooperating with the first tool part,
wherein the first tool part is movable relative to the second tool part on a linear path and/or rotated caused by the linear actuation of the shaft of the transmission device parallel to the shaft axis.

11. The forming tool according to claim 10, wherein the first tool part and the second tool part are movable relative to each other, caused by the linear actuation of the shaft of the transmission device, so that the first tool part and the second tool part move between a contact position in which the first tool part and the second tool part contact along a separation plane and at least one lifted-off position in which the first tool part is lifted off and/or rotated relative to the second tool part.

12. The forming tool according to claim 10, further comprising: an index plate-tool,
wherein the shaft includes an index shaft,
wherein the first tool part includes an index plate connected with the shaft by the first interface torque-proof and axially fixed, and
wherein the second tool part includes a form plate that is stationary.

13. The forming tool according to claim 12, wherein the index plate is configured to move at least one plastic injection-molded part to different injection-molding stations of the forming device when performing a multi-component injection-molding process.

14. The forming tool according to claim 13 wherein the forming plate and/or the index plate include form cavities or form cavity portions associated with different injection-molding stations of the forming device.

15. A plastic injection molding device configured to mold multi-component plastic injection molded parts by multi-component injection molding, the forming device comprising:
at least one forming tool according to claim 10;
a reversible linear drive that is connected with the second interface of the shaft of the transmission device in order to drive the shaft on a linear path and reversibly parallel to the shaft axis; and
at least one plasticizer configured to melt and homogenize at least one synthetic material.

16. The forming device according to claim 15 wherein the linear drive is configured as a piston-cylinder drive.

17. The transmission device according to claim 1,
wherein the at least one radial recess includes at least one branch-off or joining location,
wherein two helix shaped recess sections of the at least one helix shaped recess section adjoin the at least one linear recess section at the at least one branch-off or joining location, and wherein the two helix shaped recess sections branch off from the at least one linear recess section and from each other at the at least one branch-off or joining location, or
wherein the at least one linear recess section adjoins two helix shaped recess sections of the at least one helix shaped recess section, wherein the two helix shaped recess sections converge into the at least one linear recess section at the at least one branch-off or joining location.
